(19) United States
(12) Patent Application Publication
(10) Pub. No.: US 2023/0118410 A1
(43) Pub. Date: Apr. 20, 2023

(54) EVERYDAY RETRACTABLE UTILITY CUTTER

(71) Applicant: SLICE, INC., Sunny Isles, FL (US)

(72) Inventor: Robert Joseph Gallegos, Fremont, CA (US)

(21) Appl. No.: 17/502,090

(22) Filed: Oct. 15, 2021

(51) Int. Cl. B26B 1/08; B26B 5/00

(52) U.S. Cl. CPC B26B 1/08; B26B 5/001

(57) ABSTRACT

The present invention generally relates to a compact utility cutter. Specifically, embodiments of the present invention relate to an everyday use compact utility knife apparatus with a retractable blade. Embodiments of the compact utility knife apparatus are further comprised of a thumb slider switch configured to control the position of the blade.

### FIELD OF THE INVENTION

The present invention generally relates to a compact utility cutter. Specifically, embodiments of the present invention relate to an everyday use compact utility knife apparatus with a retractable blade. Embodiments of the compact utility knife apparatus are further comprised of a thumb slider switch configured to control the position of the blade.

### BACKGROUND

Compact utility knives are well known and used for a wide variety of tasks because of their convenient shape and size, and sharp razor-like blade. Typical compact utility knives have blades that may be extended when in use, and retracted when not in use. However, these compact utility knives lack a structure and configuration which permits the retractable blade to be fully housed within the handle in a first position and substantially extended from the handle in a second position, without compromising the strength and structure of the blade when the utility knife is in use.

Therefore, there is a need in the art for a compact utility knife that incorporates a compact and ergonomic handle configured to fully house a blade in a retracted position and provides adequate support and structure for maximum blade length in an extended position. These and other features and advantages of the present invention will be explained and will become obvious to one skilled in the art through the summary of the invention that follows.

### SUMMARY OF THE INVENTION

Accordingly, it is an aspect of the present invention to provide a utility knife with a compact and ergonomic handle configured to fully house a blade in a retracted position and provides adequate support and structure for maximum blade length in an extended position. Furthermore, it is an aspect of the present invention to provide a compact cutting tool that is capable of making nimble, accurate cuts.

According to an embodiment of the present invention, a compact utility knife may include: a main body housing, including a front-half body shell configured with a slider switch slot, a rear-half body shell, and a blade outlet slot, wherein the blade outlet slot is formed at a front edge of the main body housing from a notch in each of the front-half body shell and the rear-half body shell, a thumb slider switch configured to pass through the slider switch slot in the front-half body shell and having one or more tab members configured to align with a slider switch track and engage with the blade to form a blade control unit that is movable between at least two positions, wherein a first position of the at least two positions is when the thumb slider switch and the blade are in a rear position and the cutting blade is retracted into and substantially covered by the main body housing, and wherein a second position of the at least two positions is when the thumb slider switch and the blade are in a forward position and the cutting blade is extended from the blade outlet slot. In some embodiments, the utility knife may include a slider switch track able to lock the blade in at least one of the at least two positions, as desired by a user, and at least one spring plate component configured to bias the blade to one or more locking points, for example, to cause the cutting blade to be retained in a first position when the slider switch is in the first position, and wherein the at least one spring plate component causes the cutting blade to be retained in a second position when the slider switch is in the second position.

According to an embodiment of the present invention, the slider switch slot may define a movement limit boundary for the first position and the last position of the thumb slider switch.

According to an embodiment of the present invention, the thumb slider switch may engage with the cutting blade to facilitate the movement of the blade from the first position to the second position.

According to an embodiment of the present invention, the front-half body shell may further include a slider switch track formed on the interior of the front-half body shell and may be adapted to guide the movement of the cutting blade.

According to an embodiment of the present invention, the main body housing may further include a front housing engagement means that is adapted to align and connect a front edge of a front-half body section to a front edge of a rear-half body section.

According to an embodiment of the present invention, the main body housing may further include a rear housing engagement means that is adapted to align and connect a back edge of a front-half body section to a back edge of a rear-half body section.

According to an embodiment of the present invention, the cutting blade may be configured to be exposed when the thumb slider switch is in the second position and substantially retracted and/or covered when the thumb slider switch is in the first position.

According to an embodiment of the present invention, the at least two positions correspond to at least two cutting blade positions selected from a group of cutting blade positions comprising a fully retracted cutting blade, a partially extended cutting blade, and fully extended cutting blade.

The foregoing summary of the present invention should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

Accompanying this written specification is a collection of drawings of exemplary embodiments of the present invention. One of ordinary skill in the art would appreciate that these are merely exemplary embodiments, and additional and alternative embodiments may exist and still be within the spirit of the invention as described herein.

FIG. 1 is a top perspective view of a compact utility knife with a retracted blade in accordance with an embodiment of the present invention;

FIG. 2 is bottom perspective view of a compact utility knife with a retracted blade in accordance with an embodiment of the present invention;

FIG. 3 is a top view of a compact utility knife with a retracted blade in accordance with an embodiment of the present invention;

FIG. 4 is a top exploded perspective view of a manually extendable and retractable compact utility knife in accordance with an embodiment of the present invention;

FIG. 5 is a bottom exploded perspective view of a manually extendable and retractable compact utility knife in accordance with an embodiment of the present invention;

FIG. 6 is a top perspective view of a compact utility knife with an extended blade in accordance with an embodiment of the present invention;

FIG. 7 is an exploded view of a manually extendable and retractable compact utility knife in accordance with an embodiment of the present invention; and

FIG. 8 is an exploded view of an automatic retracting compact utility knife in accordance with an embodiment of the present invention.

### DETAILED SPECIFICATION

The present invention generally relates to a compact utility knife. Specifically, embodiments of the present invention relate to a compact utility knife apparatus with a retractable blade. Embodiments of the compact utility knife apparatus are further comprised of a thumb slider switch configured to selectively direct the position of the blade.

According to an embodiment of the present invention, the compact utility knife may be comprised of a main body housing, a thumb slider switch, a slider switch track, a blade, and a blade outlet slot. Certain embodiments of the present invention may include fewer components or additional components depending on the utilization and purpose for the compact utility knife.

According to an embodiment of the present invention, the main body housing of the compact utility knife may be configured to retain the thumb slider switch, the slider switch track, and the blade. In some embodiments, the main body housing may be comprised of a unitary body shell or two corresponding halves, a front-half body shell and a rear-half body shell, that may be configured to contain the other components of the compact utility knife. In an exemplary embodiment of the present invention, the main body housing may comprise a front housing engagement means and a rear housing engagement means that are configured to align and connect the front-half body shell with the rear-half body shell. The main body housing may further comprise a blade outlet slot (at a front edge of the compact utility knife). In some embodiments, the main body housing may be primarily flat and roughly rectangular in shape. In some examples, at least a portion of the main body housing may include one or more textured portions comprising, for example, one or more ridge members, configured to support user grip. One of ordinary skill in the art would appreciate that the main body housing could be designed in any number of configurations, and embodiments of the present invention are contemplated for use with any such configuration.

According to an embodiment of the present invention, the main body housing of the compact utility knife may comprise a front-half body shell. In some embodiments, the front-half body shell may include an outer slider switch slot. In some embodiments, the outer slider switch slot may be a void formed in the general center of the front-half body shell that may create a passage to an internal portion of the compact utility knife. One of ordinary skill in the art would appreciate that are numerous suitable configurations for the front-half body shell of the compact utility knife, and embodiments of the present invention are contemplated for use with any such configuration.

According to an embodiment of the present invention, the main body housing of the compact utility knife may comprise a rear-half body shell. In some embodiments, the rear-half body shell may comprise a connector post track and a connector post slot. In some embodiments, the rear-half body shell may be integrally formed with the connector post track. In some embodiments, the connector post track may be separate component configured to connect with the rear-half body shell. In some embodiments, either or both of the rear-half body shell and the connector post track may comprise a connector post slot. In some examples, a connector post slot may be a void formed in the general center of the connector post track and/or the rear-half body shell that may create a passage for the blade connector post to move from a first position to a second position. In an exemplary embodiment of the present invention, the connector post slot may be configured to retain the blade connector post extending from the thumb slider switch along the path between a selection of preset positions, including a rear position and a forward position. One of ordinary skill in the art would appreciate that are numerous suitable configurations for the rear-half body shell of the compact utility knife, and embodiments of the present invention are contemplated for use with any such configuration.

According to an embodiment of the present invention, the compact utility knife may include a slider switch track. In some embodiments, the slider switch track may be disposed between the blade and the front-half body shell. In some embodiments, the connector post track and the slider switch track may collectively form a blade holder. In some embodiments, the slider switch track may include an inner slider switch slot. In some embodiments, the inner slider switch slot may be a void formed on the slider switch track, for example, in the general center of the slider switch track, that creates a passage for the thumb slider switch to move from a first position to a second position. In some embodiments, the inner slider switch slot may define the movement boundary of the thumb slider switch.

In some embodiments, for example, in a manually extendable and retractable embodiment of the utility knife, an inner slider switch slot may include one or more locking elements. In some embodiments, the locking elements may be notches. In some embodiments, the notches may be disposed along the inner slider switch slot in pairs, with each notch of the pair substantially opposite a second notch of the pair. In some embodiments, each pair of notches may be configured to stabilize and secure the thumb slider switch in a user selected position of a set of preselected positions. For example, a pair of tab members extending from the thumb slider switch may be configured to correspond to the size and orientation of a pair of notches in the inner slider switch slot such that when the tab members of the thumb slider switch rest within the notches, the thumb slider switch, and the blade operably connected thereto, may be substantially locked in the position corresponding to the position of the notches. In some embodiments, a rear side of the slider switch track may include one or more paths for the tab members extending from the thumb slider switch to slide on between each pair of notches.

In some embodiments, for example, in an automatically retractable embodiment of the utility knife, the inner slider switch slot may be formed with one or more elongated grooves. In some examples, the elongated grooves may be configured to support and stabilize the movement of the thumb slider switch. For example, one or more tab members extending from the thumb slider switch may be configured to travel along the one or more grooves of the inner slider switch slot. In some examples, the slider switch may be adapted to connect to a slider switch carrier. In some examples, the slider switch carrier may be formed with an opening adapted to receive the connector post of the slider switch. In some examples, either or both of the slider switch and the slider switch carrier may be formed with a hook or similar type of fastener configured to receive or connect to a first side of the slider switch tension component. In some examples, the slider switch track may include a protruding element adapted to receive or hold a second side of the slider switch tension component. For example, the protruding element may be a post, hook, loop, or any other suitable element protruding from the slider switch track and configured to engage with the slider switch tension component in a manner that permits the slider switch tension component to extend and retract.

In some examples, for example, in automatically retracting utility knife assemblies, the thumb slider switch may be pushed to overcome the tension provided by the slider switch tension component to travel along or within the inner slider switch slot, with one or more tabs of the thumb slider switch traveling along the one or more grooves of the inner slider switch slot to extend a blade operably connected to the thumb slider switch out of a blade outlet slot in the main body housing. In some embodiments, the thumb slider switch may be tensioned to return to a retracted position, and may be configured to travel along the one or more grooves of the inner slider switch track to stably return to the retracted position. One of ordinary skill in art would appreciate that there are numerous types and configurations for a slider switch track, and embodiments of the present invention are contemplated for use with any such slider switch track.

According to an embodiment of the present invention the compact utility knife may include a thumb slider switch which may be referred to herein as a slider switch. In some embodiments, the thumb slider switch, the connector post track, and the slider switch track may collectively form a blade control unit. In accordance with embodiments of the present invention, the thumb slider switch may be configured to control the movement of the cutting blade disposed within the main body housing. In some embodiments, the thumb slider switch may be operably connected to the blade and may be configured to move the blade from a first position to a second position. In some embodiments, the thumb slider switch may include a blade engagement element. In some embodiments, the blade engagement element may be a blade connector post which extends from a bottom portion of the thumb slider switch. In some embodiments, the blade connector post may correspond in shape to a void formed in the blade. In some embodiments, the blade connector post may be configured to operably connect the thumb slider switch to the blade. In accordance with embodiments of the present invention, the thumb slider switch may include one or more tab members. In some embodiments, one or more of the tab members may protrude from one or more of the sides or edges of the thumb slider switch. In an exemplary embodiment, a pair of tab members may be positioned substantially across from one another and may be configured to travel on or adjacent to the inner slider switch slot disposed on the slider switch track within the main body housing. In some examples, the positions of the tab members may be staggered. In some examples, each tab member of the slider switch may be substantially the same or similar size, or may vary in size, depending on the intended application of the device. In some embodiments, for example, in a manually extendable and retractable embodiment of the utility knife, the tab members may be configured to engage with the inner slider switch slot in a manner that permits the thumb slider switch, and the blade operably connected thereto, to lock in a user-selected position of a set of preselected positions along the inner slider switch slot, for example, in positions along the inner slider switch slot where notches are formed. In some examples, for example, in an automatically retractable embodiment of the utility knife, the tab members of the thumb slider switch may be configured to travel along elongated grooves disposed along the inner slider switch slot, and may be configured to assist the thumb slider switch in stably returning to a retracted position when so biased by the slider switch tension component. One of ordinary skill in art would appreciate that there are numerous types and configurations for a thumb slider switch, and embodiments of the present invention are contemplated for use with any such thumb slider switch.

In accordance with embodiments of the present invention, the compact utility knife may comprise one or more spring plate components. In some examples, a first spring plate component may be configured as a leaf spring plate provided with one or more elongated tabs and one or more arms, and may be disposed between the rear-half body shell and the connector post track. In some examples, the arms and/or the elongated tabs may be tensioned. In some examples, the arms and/or the elongated tabs may be flexible. In some examples, the elongated tab may be configured to fit within a groove in the rear-half body shell to stabilize the position of the first spring plate component. In some examples, a tensioned elongated tab may be configured to bias the blade towards the slider switch track and/or the front-half body shell. In some examples, a grind edge or side of a blade may be disposed against the arms of the first spring plate component when the blade is installed into the main body housing. In some embodiments, the first spring plate component may exert a tensioning force on the blade and bias the blade toward a front portion of the blade cavity within the housing. In some examples, this configuration may prevent unwanted or undesired movement of the blade, for example, up and/or down movement of the blade. In some examples, the first spring plate component may be configured to prevent or reduce any audible rattling of the interior components of the utility knife, or visual wiggle of the blade within the housing. For example, the first spring plate component may absorb some or all of the tolerance between the interior components of the utility cutter so that the blade may be retained in a secure position during use, in storage, or incidental movement that might otherwise produce a visual wiggle of the blade within the housing or detectible audible rattle that otherwise may be formed by moving componentry within the cutter. One of ordinary skill in art would appreciate that there are numerous types and configurations for a first spring plate, and embodiments of the present invention are contemplated for use with any such first spring plate.

According to an embodiment of the present invention, the compact utility knife may include a second spring plate component. In some embodiments, the second spring plate component may be configured as a leaf spring plate and may facilitate the locking and unlocking of the thumb slider switch along various preselected positions on the inner slider switch slot. In some embodiments, the locking of the thumb slider switch in a position may facilitate the locking of the blade in a corresponding position. In some embodiments, the second spring plate component may be a tension member. In some examples, the second spring plate component may be provided with one or more arms, for example, one or more flexible arms. In some examples, the arms may be formed with one or more openings configured to support the flexibility of the arms. In some embodiments, the arms may be disposed at or near one or more sides or edges of the second spring plate component. In some embodiments, the second spring plate component may be an elastic component or other resilient member. In some embodiments, the second spring plate component may be adapted to facilitate the locking and unlocking of the cutting blade in one of a set of pre-set positions. In an exemplary embodiment of the present invention, the second spring plate component may be disposed between the blade and the thumb slider switch. In some examples, the second spring plate component may be disposed between the slider switch track and the slider switch. In some embodiments, the second spring plate component may outwardly bias the thumb slider switch and the tab members extending therefrom. In some embodiments, the second spring plate component may bias the tab members to maintain their position within the pair of notches of the inner slider switch slot to substantially lock the thumb slider switch in the position determined by the position of the pair of notches. In some examples, the second spring plate component may absorb some or all of the tolerance between the interior components of the utility cutter so that the blade may be retained in a secure position during use, in storage, or incidental movement that might otherwise produce a visual wiggle of the blade within the housing or detectible audible rattle that otherwise may be formed by moving componentry within the cutter. One of ordinary skill in art would appreciate that there are numerous types and configurations for a second spring plate component, and embodiments of the present invention are contemplated for use with any such second spring plate component.

According to an embodiment of the present invention, the compact utility knife may include a blade. In some embodiments, the blade may be removably engaged with an ejectable blade carrier. In some examples, the blade may include a void configured to receive and corresponding in shape, size and/or orientation to a connector post extending from the slider switch. In some examples, the blade may include one or more notches. The blade may be made from any suitable material, including, but not limited to, metal, ceramic, or any combination thereof. One of ordinary skill in the art would appreciate that there are numerous configurations and materials that might be used for the blade, and embodiments of the present invention are contemplated for use with any such material or configuration.

According to an embodiment of the present invention, the blade that is used may be constructed from a ceramic material that is capable of withstanding extended use without becoming dull or unusable. Ceramic materials appropriate for such construction include, but are not limited to, Zirconium Oxide. One of ordinary skill in the art would appreciate that there are numerous ceramic materials that could be utilized with embodiments of the present invention.

According to an embodiment of the present invention, the blades used in the compact utility knife may be pointed. In some embodiments, the blades may contain rounded tips to reduce the chance of injury.

According to an embodiment of the present invention, the compact utility knife may have a manually retracting blade. In some embodiments, the blade of the compact utility knife can be extended by pushing the thumb slider switch forward, as the thumb slider switch is connectively linked to the blade via the blade connector post. In some embodiments, the blade can be incrementally extended to cut through materials of varying thicknesses. Accordingly, the thumb slider switch may lock the blade in multiple positions that correspond to the varying extension positions of the blade. To extend or retract the blade, the thumb slider switch may be depressed and/or moved to the appropriate position. Once the blade is extended or retracted to the appropriate position, the thumb slider switch may then be released and the blade may be locked into that position. In some embodiments, the thumb slider switch may be lockable in a forward position so as to cause the blade to remain extended despite pressure applied by the user of the cutting device. In some embodiments, when the thumb slider switch is released from the locked position, the blade may automatically retract into the main body section of the compact utility knife. For example, a slider switch tension component may be configured to bias the blade towards a retracted blade position such that the blade may automatically retract into the housing, when an external force (e.g. a user force) is no longer applied to the slider switch. In some scenarios, the blade may be locked in the forward position by any suitable locking means including, but not limited to, a friction fit, a latching mechanism, or a ratcheting mechanism.

According to an embodiment of the present invention, the main body housing may include a front housing engagement means and a rear housing engagement means. In some embodiments, the front housing engagement means may be a pair of corresponding connector elements configured on the front portion of each of the front-half body shell and the rear-half body shell, that are adapted to connect and align the front portion of main body housing. The front housing engagement means may be configured to connect the front-half body shell to the rear-half body shell. In some embodiments, the rear housing engagement means may similarly be a pair of corresponding connector elements configured on the rear portion of each of the front-half body shell and the rear-half body shell, that are adapted to connect and align the rear portion of main body housing. In some embodiments, the main body housing may be separable into two halves to facilitate the replacement of the cutting blade. In some embodiments, the front-half body shell and the rear-half body shell may be secured to one another by fastening members. In some embodiments, the fastening members may be screws, pins, nails or any other similar members capable of fastening the front-half and rear-half body shells. One of ordinary skill in the art would appreciate that the each of the housing engagement could be adapted with a number of designs, and embodiments of the present invention are contemplated for use with any suitable design.

According to an embodiment of the present invention, the main body housing may comprise a blade outlet slot. In some embodiments, the blade outlet slot may be formed along an edge of the main body housing. In an exemplary embodiment, a notch in the edges of each of the front-half body shell and rear-half body shell may collectively form the blade outlet slot when the two halves are connected together.

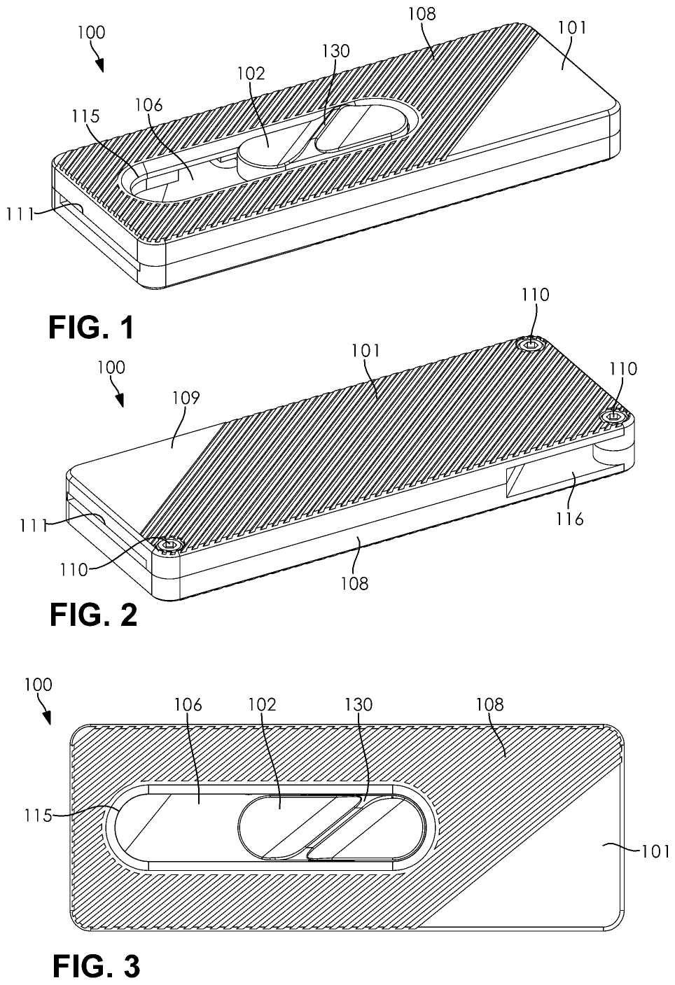

Turning now to FIG. 1, a top perspective view of a compact utility knife with a retracted blade, in accordance with an embodiment of the present invention, is shown. In the depicted example, the compact utility knife 100 comprises a main body housing 101, a thumb slider switch 102, a blade 106, and a blade outlet slot 111. In this view, the thumb slider switch 102 can be seen resting in a rear position in the outer slider switch slot 115 that is located on the front-half body shell 108. When the thumb slider switch 102 is in the rear position, the blade 106 is retracted. As shown in the depicted example, in some embodiments, the thumb slider switch 102 may be configured with a protruding actuator portion 130 that allows a user to maintain a firm grip on the thumb slider switch 102. In accordance with embodiments of the present invention, the thumb slider switch 102 may be configured to move within the outer slider switch slot 115, from a rear position to a forward position, and vice versa. In some embodiments, a blade cover (not shown) may extend from one or more sides of the thumb slider switch 102. In some embodiments, the blade cover (not shown) may be configured to cover the top side of the blade 106 when the blade 106 is in the rear or forward position. In some embodiments, the blade cover may block access to the blade 106 from the outer slider switch slot 115 to prevent injury. As shown in the depicted example, in some embodiments, the front-half body shell 108 may include a textured surface adapted to improve grip between the front-half body shell 108 and the hand of a user.

Turning now to FIG. 2, a bottom perspective view of a compact utility knife with a retracted blade, in accordance with an embodiment of the present invention, is shown. In the depicted example, the compact utility knife 100 is comprised of a main body housing 101, a thumb slider switch (not shown), a blade (not shown), and a blade outlet slot 111. In some embodiments, the main body housing 101 may be comprised of a front-half body shell 108 and a rear-half body shell 109 which are joined to each other through engagement means 110. In the depicted example, the engagement means 110 are screws configured to couple with rear receiving holes 134 and front receiving holes 135. In some embodiments, the engagement means may be pins, rivets, bolts, or any other reversible or permanent fastening elements. As shown in the depicted example, in some embodiments, the rear-half body shell 109 may include a textured surface adapted to improve grip between the rear-half body shell 109 and the hand of a user. In some embodiments, the compact utility knife 100 may include a connector receiving hole 116. In some embodiments, the connector receiving hole 116 may be configured to receive a connector (not shown) such as lanyard, a keychain, a cord or any of the like connector members capable of connecting the compact utility knife 100 to a second object, for example, a user's keys.

Turning now to FIG. 3, a top view of a compact utility knife with a retracted blade, in accordance with an embodiment of the present invention, is shown. In the depicted example, the compact utility knife 100 comprises a main body housing 101, a thumb slider switch 102, an outer slider switch slot 115, and a blade 106. In this view, the thumb slider switch 102 can be seen in a rear position in the outer slider switch slot 115 that is located on the front-half body shell 108. When the thumb slider switch 102 is in the rear position, the blade 106 may be retracted within the main body housing 101. In the depicted example, the thumb slider switch 102 includes a protruding actuator portion 130 that allows a user to maintain a firm grip on the thumb slider switch 102. As shown in the depicted example, in some embodiments, the front-half body shell 108 may include a textured surface adapted to improve grip between the front-half body shell 108 and the hand of a user.

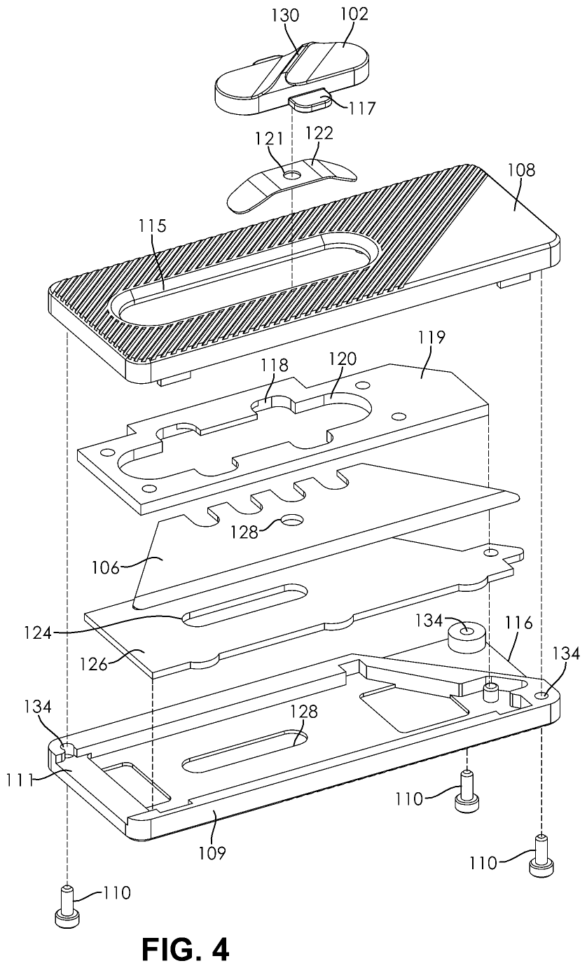

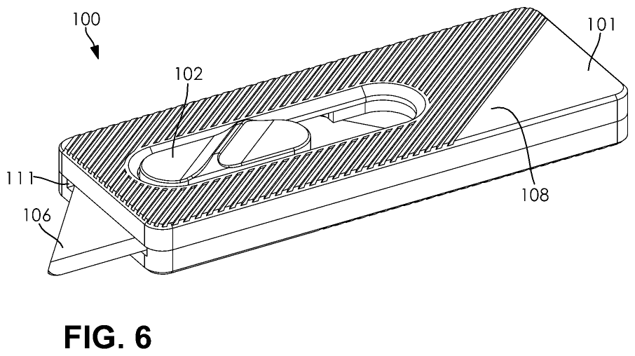

Turning now to FIGS. 4-5 and 7, exploded perspective views of a manual compact utility knife, in accordance with embodiments of the present invention, are shown. In the depicted embodiments, the components that comprise the compact utility knife 100 include a main body housing 101, a thumb slider switch 102, an outer slider switch slot 115, a blade 106, and a blade outlet slot 111. In some embodiments, the main body housing 101 may substantially contain the other components. In some embodiments, the compact utility knife 100 may include a blade control unit. In some embodiments, the blade control unit may comprise at least one of a thumb slider switch 102, a blade connector post 140, a connector post engagement point 128, a second spring plate component 122, a connector post engagement point 121, and an inner slider switch slot 120. In the illustrated example, the front-half body shell 108 includes an outer slider switch slot 115 configured as a movement boundary for the thumb slider switch 102. In some embodiments, the thumb slider switch 102 may be operably connected to the blade 106 and may be configured to enable the movement of the blade 106 from a first of a selection of positions to a second of a selection of positions. In the depicted example, a blade connector post 140 extending from the bottom side of the thumb slider switch 102 is configured to engage with the connector post engagement point 128 on the blade 106. In some embodiments, the connector post engagement point 128 is a void formed in the blade 106, substantially corresponding in size and shape to the blade connector post 140. In any embodiment, the blade 106 may be formed with one or more connector post engagement points 128 configured to engage with one or more connector posts 140 disposed on a bottom side of the thumb slider switch 102. In accordance with embodiments of the present invention, the thumb slider switch 102 may be configured to direct the movement of the blade 106 via the blade connector post 140. In accordance with embodiments of the present invention, the inner slider switch slot 120 may be configured to permit movement of the blade 106 along a variety of blade positions spanning from a fully retracted blade position (as shown in FIG. 1) to a fully extended blade position (as shown in FIG. 6). In the depicted example, the blade 106 is retracted into the main body housing 101 when the thumb slider switch 102 is in a first or rear position and the blade 106 may be extended to a fully extended blade position when the thumb slider switch 102 is in a second or forward position.

As further shown in FIGS. 4-5 and 7, in some examples of the present invention, the thumb slider switch 102 may include one or more tab members 117. In some embodiments, a pair of tab members 117 may protrude from the sides of the thumb slider switch 102 and may be positioned substantially across from one another, or may be staggered. In the illustrated embodiment, the tab members 117 are configured to travel on or adjacent to the inner slider switch slot 120 disposed on the slider switch track 119 within the main body housing 101. In some embodiments, the rear side of the slider switch track 119 includes one or more paths 142 for the tab members 117 to slide along between each pair of tab member locking notches 118. In some embodiments, the tab members 117 may be configured to engage with the inner slider switch slot 120 in a manner that permits the thumb slider switch 102, and the blade 106 operably connected thereto, to lock in a user-selected position of a set of preselected positions. In the depicted example, the second spring plate component 122 disposed between the thumb slider switch 102 and the blade 106 facilitates the locking and unlocking of the thumb slider switch 102 along various preselected positions on the inner slider switch slot 120. In an exemplary embodiment of the present invention, the locking of the thumb slider switch 102 in a particular position contributes to the locking of the blade 106 in a corresponding position.

In some embodiments, the second spring plate component 122 is a spring-like member. In some embodiments, the second spring plate component 122 may be a flexible or elastic component or other resilient tension component. In the illustrated example, the second spring plate component 122 is disposed between the blade 106 and the thumb slider switch 102. In some embodiments, the interior side of the thumb slider switch 102 may include a depressed portion which is configured to receive at least a portion of the second spring plate component 122 in both its extended and its retracted orientations. For example, when a user presses on the thumb slider switch 102, the second spring plate component 122 may be configured to flatten or retract, such that the thumb slider switch 102 may move closer to the rear-half body shell 109 of the main body housing 101. In some embodiments, the second spring plate component 122 may outwardly bias the thumb slider switch 102 and the tab members 117. For example, the second spring plate component 122 may bias the thumb slider switch 102 and the tab members 117 such that when the thumb slider switch 102 is at rest, the tab members 117 are biased by the second spring plate component 122 to maintain their position within the pair of notches 118 of the inner slider switch slot 120 to substantially lock the thumb slider switch 102 to a location determined by the position of the pair of notches 118. In the illustrated example, the second spring plate component 122 includes a connector post engagement point 121 configured to receive the blade connector post 140. In some embodiments, the blade connector post extends from the thumb slider switch 102, through the second spring plate component 122, and into the blade 106. In any embodiment, the second spring plate component 122 may include one or more post engagement points 121 adapted to engage with one or more connector posts 140 of the thumb slider switch 102. As shown in the depicted example, in some embodiments, the blade connector post 140 is further configured to extend through one or more connector post slots 124 in the connector post track 126 and/or the rear-half body shell 109. In some embodiments, the blade connector post 140 may be further configured to extend into the switch connector post groove 128 disposed on the interior surface of the rear-half body shell 109.

In accordance with embodiments of the present invention, the slider switch track 119 may include an inner slider switch slot 120. In some embodiments, the inner slider switch slot 120 may be a void formed in the general center of the slider switch track 119 that creates a passage for the thumb slider switch 102 to move at least from a first position to a second position. In some embodiments, the inner slider switch slot 120 may define the movement boundary of the thumb slider switch 102. In the illustrated embodiment, the inner slider switch slot 120 includes one or more notches 118. In the depicted example, the notches 118 are disposed along the inner slider switch slot 120 in pairs, each notch of the pair substantially opposite a second notch of the pair. In some examples, the notches 118 of the inner slider switch slot 120 may be staggered and may be configured to correspond to the position of the tab members 117, for example, staggered tab members 117, disposed on the thumb slider switch 102. In some embodiments, each pair of notches 118 may be configured to stabilize and secure the thumb slider switch 102 in a user selected position of a set of preselected notch positions. For example, a pair of tab members 117 extending from the thumb slider switch 102 may be configured to correspond to the size and orientation of a pair of notches 118 in the inner slider switch slot 120 such that when the tab members 117 of the thumb slider switch 102 rest within the notches 118, the thumb slider switch 102, and the blade 106 operably connected thereto, are substantially locked in the position corresponding to the position of the notches 118. In some embodiments, the rear side of the slider switch track 119 may be include one or more paths 142 for the tab members 117 extending from the thumb slider switch 102 to slide along between each pair of notches 118. In some embodiments, the connector post track 126 and the slider switch track 119 may collectively form a blade holder.

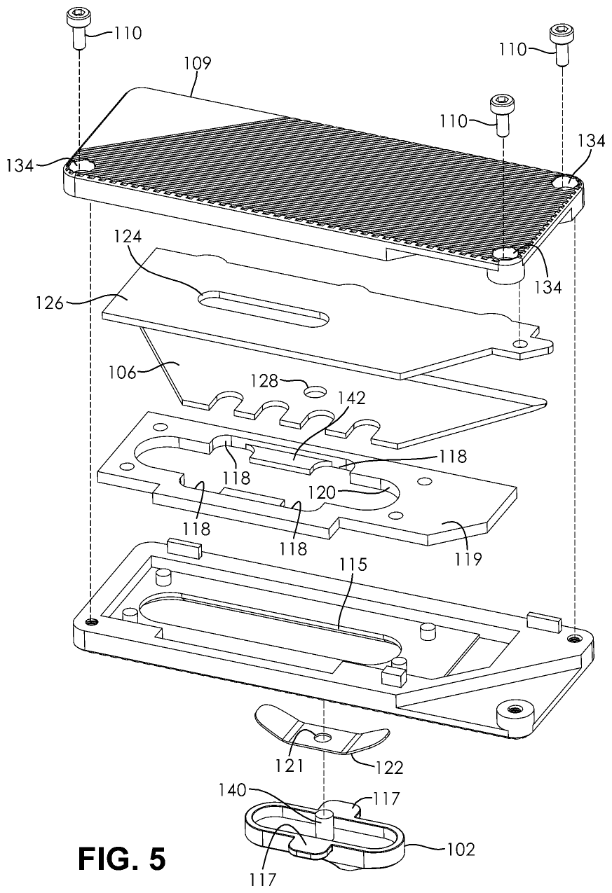

As further shown in FIGS. 4-5 and 7, the rear-half body shell 109 may be configured to engage with the connector post track 126. As shown in FIG. 5, the connector post track 126 may include a connector post slot 124 configured as a void in the general center of the slider switch track 126 that creates a passage for the blade connector post 140 to move from a first of a selection of positions to a second of a selection of positions. In an exemplary embodiment of the present invention, the connector post slot 124 may be configured to secure the blade connector post 140 extending from the thumb slider switch 102 to the path between a selection of preset positions, including a rear position and a forward position.

Turning now to FIG. 6, a top perspective view of a compact utility knife with an extended blade, in accordance with an embodiment of the present invention, is shown. In the depicted example, the compact utility knife 100 is comprised of a main body housing 101, a thumb slider switch 102, a blade 106, and a blade outlet slot 111. In this view, the thumb slider switch 102 can be seen in a forward position in the outer slider switch slot 115 that is located on the front-half body shell 108. When the thumb slider switch 102 is in the forward position, the blade 106 is extended past the blade outlet slot 111.

Turning now to FIG. 8, an exploded view of an automatic retracting compact utility knife in accordance with an embodiment of the present invention, is shown. In the depicted example, the components that comprise the compact utility knife 100 include a main body housing 101, a thumb slider switch 102, an outer slider switch slot 115, a blade 106, and a blade outlet slot 111. In some embodiments, the main body housing 101 may substantially contain the other components. In some embodiments, the compact utility knife 100 may include a blade control unit. In some embodiments, the blade control unit may comprise at least one of the thumb slider switch 102, the blade connector post 140 (as shown in FIG. 5), the connector post engagement point 128, the connector post engagement point 121, and the inner slider switch slot 131. In the illustrated example, the front-half body shell 108 includes an outer slider switch slot 115 configured as a movement boundary for the thumb slider switch 102. In some embodiments, the thumb slider switch 102 may be operably connected to the blade 106 and may be configured to enable the movement of the blade 106 from a first of a selection of positions to a second of a selection of positions. In the depicted example, a blade connector post 140 extending from the bottom side of the thumb slider switch 102 is configured to engage with the connector post engagement point 128 on the blade 106. In some embodiments, the connector post engagement point 128 may be a void formed in the blade 106, substantially corresponding in size and shape to the blade connector post 140. In any embodiment, the blade 106 may be formed with one or more connector post engagement points 128 configured to engage with one or more connector posts 140 disposed on a bottom side of the thumb slider switch 102. In accordance with embodiments of the present invention, the thumb slider switch 102 may be configured to direct the movement of the blade 106 via the blade connector post 140.

As further shown in FIG. 8, in some examples of the present invention, the thumb slider switch 102 may include one or more tab members 117. In some embodiments, a pair of tab members 117 may protrude from the sides of the thumb slider switch 102 and may be positioned substantially across from one another, or may be staggered. As demonstrated in the illustrated embodiment, in some examples, the tab members 117 may be configured to travel on or adjacent to an inner slider switch slot 131 which may be disposed on the slider switch track 129 within the main body housing 101. As shown in the depicted example, the inner slider switch slot 131 may be formed with one or more elongated grooves 133. In some examples, the elongated grooves 133 may be configured to support and stabilize the movement of the slider switch 102. For example, one or more tab members 117 extending from the thumb slider switch 102 may be configured to travel along the one or more elongated grooves 133 of the is disposed between the slider switch and the blade and is configured to bias the tab members toward the front side of the housing to reversibly secure the tab members to a preselected blade position slot 131. In some examples, the slider switch 102 may be adapted to connect to a slider switch carrier 112. In some examples, the slider switch carrier may be formed with an opening 113 adapted to receive the connector post 140 (as shown in FIG. 5) of the slider switch 102. In some examples, the slider switch 102 or slider switch carrier 112 may be formed with a hook 125 or similar type of fastener configured to receive or connect to a portion of the slider switch tension component 137. In some examples, the thumb slider switch 102 may be pushed to overcome tension exerted by a slider switch tension component 137 to travel along or within the inner slider switch slot 131, with one or more tabs 117 of the thumb slider switch 102 traveling along the one or more grooves 133 of the inner slider switch slot 131 to extend a blade 106 operably connected to the thumb slider switch 102 out of a blade outlet slot 111 in the main body housing 101. In some embodiments, the thumb slider switch 102 may be biased or tensioned to return to a retracted position, and may be configured to travel along the one or more grooves 133 of the inner slider switch track 129 to stably return the blade 106 to the retracted position.

In accordance with embodiments of the present invention, the slider switch track 129 may include an inner slider switch slot 131. In some embodiments, the inner slider switch slot 131 may be a void formed in the general center of the slider switch track 129 that creates a passage for the thumb slider switch 102 to move at least from a first position to a second position. In some embodiments, the inner slider switch slot 131 may define the movement boundary of the thumb slider switch 102. In the illustrated embodiment, the inner slider switch slot 131 includes an elongated groove 133. In any example, the inner slider switch slot 131 may include one or more elongated grooves 133. In the depicted example, the elongated groove 133 is disposed along the inner slider switch slot 131. In some embodiments, the elongated groove(s) 133 may be configured to stabilize the movement of the thumb slider switch 102. In some embodiments, the elongated groove(s) 133 may be configures as paths for the tab members 117 extending from the thumb slider switch 102 to slide along.

As further shown in FIG. 8, the rear-half body shell 109 may be configured to engage with the connector post track 126. In some examples, the connector post track 126 may include a connector post slot 124 configured as a void in the general center of the slider switch track 126 that creates a passage for the blade connector post 140 (as shown in FIG. 5) to move from a first of a selection of positions to a second of a selection of positions. In some examples, the rear-half body shell 109 may be formed with a connector post slot. In an exemplary embodiment of the present invention, the switch connector slot 124 may be configured to secure the blade connector post 140 extending from the thumb slider switch 102 to the path between a selection of preset positions, including a rear position and a forward position.

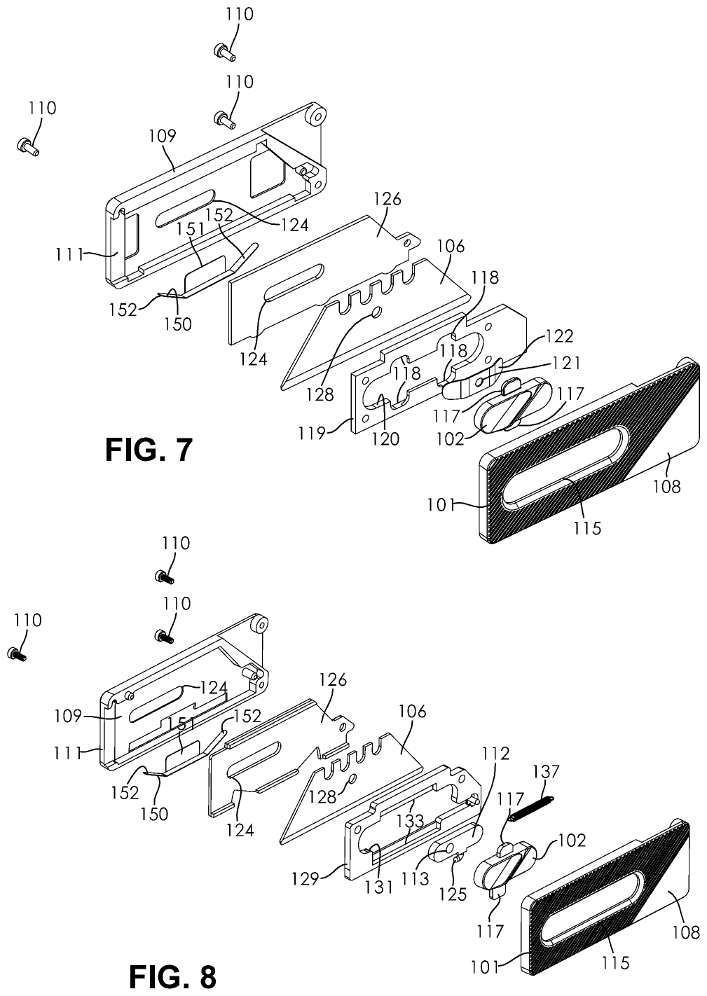

As shown in FIGS. 7 and 8, the compact utility knife 100 may include a first spring plate component 150. In some examples, the first spring plate component 150 may be configured as a leaf spring plate provided with one or more elongated tabs 151 and one or more arms 152, for example, and may be disposed between the rear-half body shell 109 and the connector post track 126. In some examples, the arms 152 and/or the elongated tabs 151 may be tensioned. In some examples, the arms 152 and/or the elongated tabs 151 may be flexible. In some examples, the elongated tab 151 may be configured to fit within a groove 105 in the rear-half body shell 109 to stabilize the position of the first spring plate component 150. In some examples, a tensioned elongated tab 151 may be configured to bias the blade 106 towards the slider switch track 119 or 129 and/or the front-half body shell 108. In some examples, a grind edge or side of a blade 106 may be disposed against the arms 152 of the first spring plate component 150 when the blade 106 is installed into the main body housing 101. In some embodiments, the first spring plate component 150 may exert a tensioning force on the blade 106 and bias the blade 106 toward a top edge of the blade cavity within the housing 101. In some examples, this configuration may prevent unwanted or undesired movement of the blade 106, for example, unintentional up and/or down movement of the blade 106. In some examples, the first spring plate component 150 may be configured to prevent or reduce any audible rattling of the interior components of the utility knife 100, or visual wiggle of the blade 106 within the housing. For example, the first spring plate component 150 may absorb some or all of the tolerance between the interior components of the utility cutter 100 so that the blade 106 may be retained in a secure position during use, in storage, or incidental movement that might otherwise produce a visual wiggle of the blade 106 within the housing or detectible audible rattle that otherwise may be formed by moving componentry within the cutter 100.

In an exemplary usage scenario, the compact utility knife 100 of the present invention may be utilized by unlocking the thumb slider switch 102 to permit the user controlled movement of the blade 106 from a selection of retracted and extended positions. This may be accomplished by pressing down the thumb slider switch 102 to eject the tab members 117 from within a first notch position in a first pair of notches 118 of the inner slider switch slot 120 and sliding the thumb slider switch 102 along the inner slider switch track 120 towards a second notch position. The thumb slider switch 102 may then optionally be locked within a second pair of notches 118 in a second notch position by releasing the user induced pressure on the thumb slider switch 102 such that the tension component 122 may bias the tab members 117 of the thumb slider switch 102 into the second notch position. Accordingly, the blade 106, engaged with the thumb slider switch 102, may be moved from a first notch position corresponding to a retracted blade position to a second notch position corresponding to an extended blade position. In the extended position, the blade 106 is configured to protrude from the blade outlet slot 111 to enable a user to use the blade to cut or slice materials, as desired by the user.

In accordance with embodiments of the present invention, the compact utility knife comprises a main body housing configured as a compact and ergonomic blade handle. In accordance with embodiments of the present invention, the compact utility knife is configured to, despite its relatively small size, fully house a blade in a retracted position and allow for maximum blade length in an extended position, without compromising the strength and structure of the blade when the blade is extended and the utility knife is in use.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A cutting device, comprising:
a housing configured to retain a blade; and
a movable slider switch operably connected to and adapted to move the blade between a selection of retracted and extended positions; and
one or more track components, each track component having a slot defining a channel that guides the movement of the slider switch.

2. The cutting device of claim 1, wherein a connector post extending from the slider switch is configured to pass through a void disposed in each of the front side of the housing, the track component and the blade in order to permit the slider switch to control the movement of the blade.

3. The cutting device of claim 1, further comprising one or more spring plate components, wherein a first spring plate component is configured to bias the blade towards a front portion of the housing to stabilize the position of the blade, and a second spring plate component is disposed between the slider switch and the blade and is configured to bias one or more tab members extending from the slider switch toward the front portion of the housing to reversibly secure the tab members to a preselected blade position.

4. A cutting device, comprising:
a housing configured to retain a blade;
a movable slider switch having protruding tab members, the slider switch operably connected to and adapted to move the blade between a selection of retracted and extended positions;
a blade holder comprising one or more track components, wherein a first track component includes a slider switch slot defining a channel adapted to guide the movement of the slider switch, the channel having one or more locking elements configured to releasably receive the tab members of the slider switch, each locking element defining a preset blade position; and
one or more spring plate components, wherein at least one spring plate component is disposed between the slider switch and the blade and is configured to bias the tab members toward the front side of the housing to reversibly secure the tab members to a preselected blade position.

5. The cutting device of claim 3, wherein each locking element includes a pair of notches.

6. The cutting device of claim 4, wherein a connector post extending from the slider switch is configured to pass through a void disposed in at least each of: the front side of the housing, the first track component, and the blade.

7. The cutting device of claim 5, wherein the void formed in the first track component defines a movement boundary for the slider switch.

8. The cutting device of claim 17, wherein the blade is disposed between the first track component and a second track component having a connector post slot defining a channel that guides the movement of the connector post extending from the slider switch.

9. The cutting device of claim 3, wherein the at least one spring plate component biases the tab members of the slider switch towards the closest pair of locking notches.

10. The cutting device of claim 3, wherein compressing the at least one slider switch reversibly compresses the spring plate component to release the tab members from within the locking notches and permits lateral movement of the slider switch.

11. The cutting device of claim 10, wherein the tab members are configured to travel along a path on a rear side of the first track component between a first and second pair of locking notches.

13. A cutting device, comprising:
a housing configured to retain a blade;
a movable slider switch having one or more protruding tab members and a blade connector post coupled to the blade, the slider switch adapted to move the blade between a selection of retracted and extended positions;
a blade holder comprising one or more track components, wherein a first track component comprises a slider switch slot defining a channel that guides the movement of the slider switch, the channel having on or more elongated grooves forming one or more paths for the one or more tab members of the slider switch; and
a slider switch tension component configured to bias the slider switch toward a rear end of the housing to automatically retract the blade.

14. The cutting device of claim 12, wherein the blade holder is adapted to permit controlled movement of the blade.

15. The cutting device of claim 12, wherein the blade connector post extends from a rear side of the slider switch.

16. The cutting device of claim 14, wherein the blade connector post travels through and is retained by a void in the blade.

17. The cutting device of claim 15, wherein a second track component includes a connector post slot defining a channel that guides the movement of the connector post extending from the slider switch.

18. The cutting device of claim 17, wherein the blade is disposed between the first track component and the second track component.

19. The cutting device of claim 17, wherein the connector post travels through sequential voids in the first track component, the blade, and the second track component.

20. The cutting device of claim 17, further comprising one or more spring plate components, wherein a first spring plate component is disposed between a front side of the housing and the second track component and is configured to bias the blade towards a front portion of the housing to stabilize the position of the blade, and a second spring plate component is disposed between the slider switch and the blade and is configured to bias the tab members toward the front side of the housing to reversibly secure the tab members to a preselected blade position.
